(19) United States
(12) Patent Application Publication
(10) Pub. No.: US 2025/0287257 A1
(43) Pub. Date: Sep. 11, 2025

(54) DEVICE-TO-DEVICE (D2D) LINK MAINTENANCE CONTROL

(71) Applicant: QUALCOMM INCORPORATED, San Diego, CA (US)

(72) Inventors: Yuwen ZOU, San Jose, CA (US); Davide RIZZO, San Diego, CA (US); Shekar Babu MERLA, Bangalore (IN); Sudhakar CHAKALI, Hyderabad (IN); Gilles DUBOST, Le Rouret (FR); Pavel GUZEVICH, Haifa (IL)

(21) Appl. No.: 18/597,804

(22) Filed: Mar. 6, 2024

(51) Int. Cl. H04W 28/02; H04W 76/10

(52) U.S. Cl. CPC H04W 28/0263; H04W 76/10

(57) ABSTRACT

A device-to-device data communication link may be controlled to provide link downtime for maintenance operations. In one of the devices, a link downtime request and a data traffic level indication may be provided. Then, in the device, a link downtime acknowledgement may be provided in response to the link downtime request when the data traffic level indication is less than a threshold. The device may then suspend link traffic and control a link maintenance operation in response to the link downtime acknowledgement. The device may base the data traffic level indication on not only data traffic in that device but also on data traffic in other devices coupled to the data communication link.

### DESCRIPTION OF THE RELATED ART

A device-to-device (D2D) link may enable data communication between two devices, each of which may include one or more processors. Such devices may include integrated circuit dies or chips, as well as co-packaged dies, sometimes referred to as “chiplets.” In a system that processes real-time data, such as, for example, video images, the D2D link may provide high-speed communication of real-time data traffic and be configured in accordance with a high-speed bus standard, such as, for example, Peripheral Component Interconnect express (PCIe). For example, a D2D link may couple a first die or chiplet that includes a central processing unit (CPU) to a second die or chiplet that includes a graphics processing unit (GPU). In this manner, a chiplet-based solution may provide similar performance to a single-die solution or traditional “system-on-chip” (SoC) that includes such multiple processors.

Some types of D2D links are configured to provide for so-called “maintenance” operations. Environmental temperature changes, aging of electronic components, etc., may degrade performance of a D2D link. Some types of maintenance operations may be performed on the D2D link to mitigate these effects and thus restore performance. The maintenance operations may be performed “on-the-fly,” i.e., without disabling operation of the entire system. To perform such on-the-fly maintenance operations it is generally necessary to suspend or stall D2D link operation (i.e., stall the data traffic) and then restore the D2D link operation after the maintenance operation is completed. In other instances it may be desirable to switch the operational frequency of the D2D link on the fly, i.e., during operation of the D2D link. Switching the operational frequency of the D2D link may be included within the scope of maintenance operations because it is generally necessary to stall the D2D link operation and then restore the link operation after the D2D link frequency has been switched.

Stalling D2D link operation for maintenance operations may degrade performance (e.g., data throughput) across chiplets. It would be desirable to reduce such performance degradation when stalling a D2D link for maintenance operations.

### SUMMARY OF THE DISCLOSURE

Systems, methods, and other examples for controlling a device-to-device (D2D) data communication link are disclosed.

An exemplary method for controlling a data communication link between a first device and a second device may include providing, by the first device, a link downtime request. The method may further include providing, by the first device, a data traffic level indication. The method may still further include providing, by the first device, a link downtime acknowledgement in response to the link downtime request when the data traffic level indication is less than a data traffic threshold. The method may yet further include controlling, by the first device, a link maintenance operation in response to the link downtime acknowledgement.

An exemplary system for controlling a device-to-device data communication link may include a traffic network in a device, link circuitry in the device coupled to the traffic network and the data communication link, and a traffic monitoring controller in the device coupled to the traffic network and the link circuitry. The link circuitry may be configured to provide a link downtime request. The traffic monitoring controller may be configured to provide a data traffic level indication and further to provide a link downtime acknowledgement in response to the link downtime request when the data traffic level indication is less than a data traffic threshold. The link circuitry may be further configured to control a link maintenance operation in response to the link downtime acknowledgement.

Another exemplary system for controlling a device-to-device data communication link may include a first device coupled to the data communication link and a second device coupled to the data communication link. The first device may be configured to provide a device-to-device link downtime request message based on a first data traffic level. The first device may further be configured to control a first portion of a link maintenance operation. The second device may be configured to control a second portion of the link maintenance operation based on the device-to-device link downtime request message and a second data traffic level.

### BRIEF DESCRIPTION OF THE DRAWINGS

In the Figures, like reference numerals refer to like parts throughout the various views unless otherwise indicated. For reference numerals with letter character designations such as “101A” or “101B”, the letter character designations may differentiate two like parts or elements present in the same Figure. Letter character designations for reference numerals may be omitted when it is intended that a reference numeral encompass all parts having the same reference numeral in all Figures.

FIG. 1 is a block diagram of a system having a device-to-device (D2D) data communication link coupling two dies, in accordance with exemplary embodiments.

FIG. 2 is a block diagram of one of the dies of FIG. 1, having a system for controlling D2D link maintenance operations, in accordance with exemplary embodiments.

FIG. 3 is a flow diagram illustrating a method for controlling D2D link maintenance operations, in accordance with exemplary embodiments.

FIG. 4 is a flow diagram illustrating another method for controlling D2D link maintenance operations, in accordance with exemplary embodiments.

FIG. 5 is a signal timing diagram illustrating aspects of controlling D2D link maintenance operations, in accordance with exemplary embodiments.

FIG. 6 is a block diagram of a die having a system for controlling D2D link maintenance operations, in accordance with exemplary embodiments.

FIG. 7 is a signal flow diagram illustrating aspects of controlling D2D link maintenance operations, in accordance with exemplary embodiments.

FIG. 8 is a block diagram of a computing device having a system for controlling D2D link maintenance operations, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

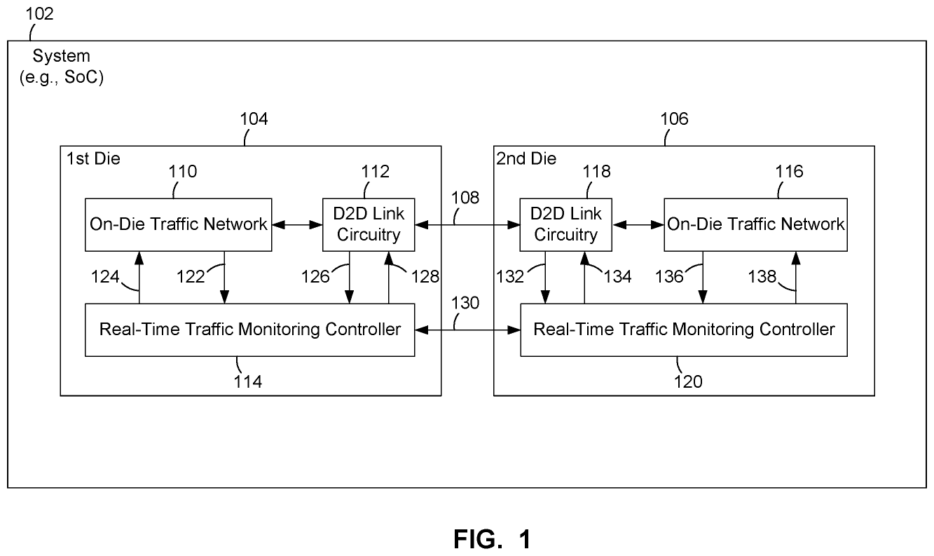

As shown in FIG. 1, in an illustrative or exemplary embodiment a system 102 may include a first device, such as a first chip or die 104, and a second device, such as a second chip or die 106. The system 102 may be a system-on-chip (SoC) or a multi-chip module in which the first and second dies 104 and 106 are so-called “chiplets.” A device-to-device (D2D) data communication link 108 may couple the first die 104 to the second die 106. The D2D link 108 may implement any data interconnect (e.g., bus) protocol or specification, such as, for example, Peripheral Component Interconnect express (PCIe), Universal Serial Bus (USB), etc. The D2D link 108 may comprise wires or other conductors (not individually shown in FIG. 1) configured to carry the bus or interconnect signals.

The system 102 may be included in a computing device (not shown), which may be of any type. For example, the system 102 may be included in a desktop or laptop computer, a datacenter processing unit, a portable computing device such as a smartphone, an automotive device, an Internet of Things (IoT) device, or a wearable device such as a wristwatch-style device, eyewear, a headset, etc. Although the computing device (not shown) may be of any type, the solutions described herein may be advantageous in a computing device that processes real-time data, such as video images captured in real-time, and thus may benefit from the D2D link 108 remaining in an operational state for long durations. Stopping traffic on the D2D link 108 to perform maintenance operations involving the D2D link 108 may degrade such real-time performance. The solutions described herein may help reduce such performance degradation.

The first die 104 may include an on-die data traffic network 110, D2D link circuitry 112, and a real-time data traffic monitoring controller 114. The second die 106 may similarly include an on-die data traffic network 116, D2D link circuitry 118, and a real-time data traffic monitoring controller 120. Except where it may be stated otherwise herein, corresponding elements of the first die 104 and the second die 106 may be similar. That is, unless otherwise described herein, the foregoing elements of the first die 104 may have the same structures and functions as the corresponding elements of the second die 106. Accordingly, for purposes of brevity only the elements of the first die 104 are described herein. Functions, events, actions, etc., described herein as occurring or performed in the first die 104 may also occur or be performed in the second die 106.

The on-die traffic network 110 may comprise any type of data communication interconnect, such as one or more buses, etc., and associated control circuitry. Although not shown in FIG. 1 for purposes of clarity, the on-die traffic network 110 may also include one or more processors or other processing circuitry. The D2D link circuitry 112 may include physical-level interface or “PHY” circuitry as well as associated control circuitry, as described below. The D2D link circuitry 112 may interface the on-die traffic network 110 with the D2D link 108. That is, the D2D link circuitry 112 may send data from the on-die traffic network 110 to the D2D link 108 for transmission to the second die 106, and may receive data from the second die 106 via the D2D link 108 and provide the received data to the on-die traffic network 110. It may be noted that the amount of data traffic being communicated by the on-die traffic network 110 may fluctuate as the one or more processing components obtain data using the on-die traffic network 110, process the data, and output results of the processing using the on-die traffic network 110. At some times the on-die traffic network 110 may be handling only a small amount of traffic, while at other times the on-die traffic network 110 may be handling a greater amount of traffic and may be nearing its maximum traffic handling capacity.

The real-time traffic monitoring controller 114 may be configured to monitor traffic level information 122 provided by the on-die traffic network 110, indicating a traffic level being handled by the on-die traffic network 110. The term “traffic level” in the context of the on-die traffic network 110 may refer, for example, to an amount of data passing through a network node (not separately shown) in an amount of time, such as some number of bits per second. The real-time traffic monitoring controller 114 may also be configured to provide traffic control information 124 to the on-die traffic network 110. In response to the traffic control information 124, the on-die traffic network 110 may throttle or slow down the rate at which the data (traffic) is sent or received.

It may be desirable to provide for so-called “maintenance” operations on the D2D link 108. Maintenance operations may include, for example, calibration operations, such as so-called “eye training,” in which the relative timing between clock and data signals is adjusted using a feedback control method, until the clock signal edge occurs at a target time with respect to the data signal “eye” (so named for the pattern the data signal may resemble on an oscilloscope). Another example of a maintenance operation is switching the operational frequency of the D2D link 108.

To perform such maintenance operations, the D2D link circuitry 112 may suspend or stall traffic on the D2D link 108. For maintenance operations that involve bidirectional communication, both the D2D link circuitry 112 in the first die 104 and the corresponding D2D link circuitry 118 in the second die 106 may stall traffic on the D2D link 108. That is, the D2D link circuitry 112 and 118 may cease communicating data with each other over the D2D link 108. The D2D link circuitry 112 (or both D2D link circuitry 112 and 118) may perform or control the maintenance operation while they are not communicating data over the D2D link 108, i.e., during the “downtime” while the traffic is stalled. Then, when the maintenance operation is completed, the D2D link circuitry 112 (or both D2D link circuitry 112 and 118) may restore operation of the D2D link 108. That is, the D2D link circuitry 112 and 118 may resume communicating data with each other over the D2D link 108.

The D2D link circuitry 112 may determine when a maintenance operation is to be performed. The D2D link circuitry 112 may make this determination based on any of various factors. For example, it may be determined to perform eye training at periodic time intervals (e.g., based on a timer). Alternatively, or in addition, it may be determined to perform eye training when the D2D link circuitry 112 detects that degradation of the eye signal timing has exceeded a degradation threshold, or detects that a key performance indicator (KPI) has exceeded a threshold. It may also be determined to switch the D2D link operational frequency based on a request from a power management subsystem (not shown). For example, the power management system may request a reduction in D2D link operational frequency to save power based on operational conditions.

When the D2D link circuitry 112 determines that a maintenance operation is to be performed, the D2D link circuitry 112 may assert a downtime request signal 126. In response to assertion of the downtime request signal 126, the real-time traffic monitoring controller 114 may determine whether to assert a downtime acknowledgement signal 128. When the downtime acknowledgement signal 128 is asserted, the D2D link circuitry 112 may cease communicating data over the D2D link 108 and may proceed with controlling or performing the maintenance operation. If the downtime acknowledgement signal 128 is not asserted in response to the downtime request signal 126, the D2D link circuitry 112 may refrain from beginning the maintenance operation.

The real-time traffic monitoring controller 114 may determine whether to assert the downtime acknowledgement signal 128 in response to assertion of the downtime request signal 126 based on a data traffic level. For example, the real-time traffic monitoring controller 114 may refrain from asserting the downtime acknowledgement signal 128 unless the data traffic level is less than a threshold. This data traffic level may be based on a measurement of the data traffic being handled by the on-die traffic network 110 and may further be based on an aggregation (e.g., a sum) of that traffic level measurement with a measurement of the data traffic correspondingly being handled by the on-die traffic network 116 in the second die 106.

The real-time traffic monitoring controller 114 in the first die 104 and the real-time traffic monitoring controller 120 in the second die 106 may communicate or exchange status information 130 with each other. The status information 130 may include the traffic level being handled by the on-die traffic network 110 and the traffic level being handled by the on-die traffic network 116. That is, the real-time traffic monitoring controller 120 in the second die 106 may provide status information 130 that includes an indication of the traffic level being handled by the on-die traffic network 116. Likewise, the real-time traffic monitoring controller 114 in the first die 104 may provide status information 130 that includes an indication of the traffic level being handled by the on-die traffic network 110. The real-time traffic monitoring controller 114 in the first die 104 may determine an aggregate traffic level, such as a sum of an indication of the traffic level being handled by the on-die traffic network 110 and a received indication of the traffic level being handled by the on-die traffic network 116 in the second die 106. Likewise, the real-time traffic monitoring controller 120 in the second die 106 may determine an aggregate traffic level, such as a sum of an indication of the traffic level being handled by the on-die traffic network 116 in combination with a received indication of the traffic level being handled by the on-die traffic network 110 in the first die 104.

Although the operations described above relate mainly to the first die 104, it should be understood that the same operations may apply to the second die 106. That is, the D2D link circuitry 118 in the second die 106 may determine that a maintenance operation is to be performed (independently of any such determination in the first die 104), issue a downtime request 132, receive a downtime acknowledgement 134, etc. The real-time traffic monitoring controller 120 in the second die 106 may be configured to monitor traffic level information 136 from the on-die-traffic network 116 and provide traffic control information 138 to the on-die traffic network 116. Also, although the exemplary system 102 include two dies 104 and 106, other examples of systems (not shown) may include more than two dies communicating with each other via a D2D link.

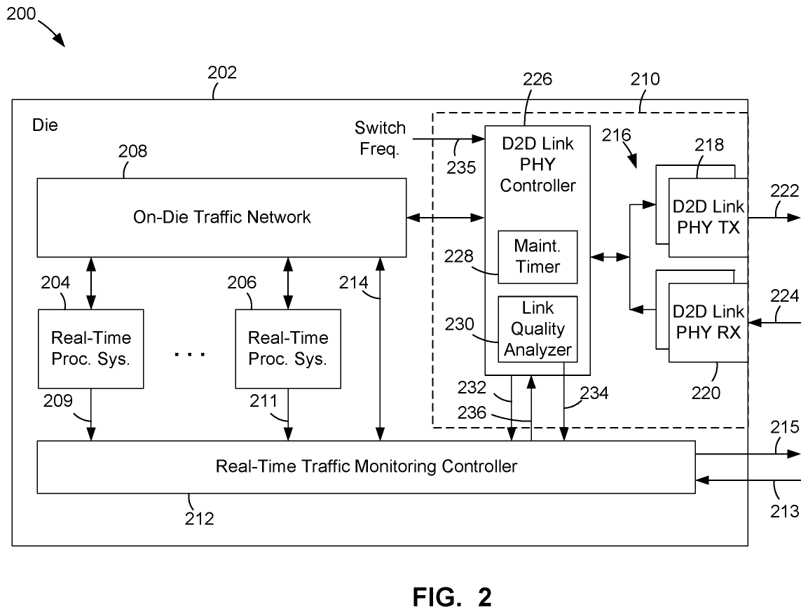

As shown in FIG. 2, a system 200 for controlling a D2D data communication link may comprise a device such as a die 202. The die 202 may include any number of real-time processing systems 204-206, an on-die traffic network 208, D2D link circuitry 210, and a real-time traffic monitoring controller 212. The die 202, on-die traffic network 208, D2D link circuitry 210, and real-time traffic monitoring controller 212 may be examples of the above-described (FIG. 1) on-die data traffic network 110, D2D link circuitry 112, and real-time traffic monitoring controller 114, respectively, of the first die 104, or the on-die data traffic network 116, D2D link circuitry 118, and real-time data traffic monitoring controller 120, respectively, of the second die 106.

The real-time traffic monitoring controller 212 and the on-die traffic network 208 may exchange traffic level monitoring and throttling signals 214, in a manner similar to that described above (FIG. 1) with regard to the traffic level information 122 and traffic control information 124. In addition, or alternatively, the real-time traffic monitoring controller 212 may receive traffic level monitoring signals 209-211 directly from the real-time processing systems 204-206. The traffic level monitoring signals 209-211 may indicate traffic levels being handled by the respective real-time processing systems 204-206. The real-time traffic monitoring controller 212 thus may be configured to monitor a traffic level and to throttle traffic in the on-die traffic network 208.

The traffic level monitored by the real-time traffic monitoring controller 212 may be an aggregate of a traffic level in the on-die traffic network 208 and traffic levels in other devices, such as the real-time processing systems 204-206. Such other devices may also include a similar on-die traffic network, similar real-time processing systems, etc., of another die (not shown in FIG. 2). The traffic level in the on-die traffic network 208 or other such device may be determined based on, for example, the fullness of one or more data buffers (not separately shown) in the traffic network or device. Such traffic levels in other dies may be received by the real-time traffic monitoring controller 212 from the one or more other dies in the form of D2D traffic status information 213. Note that the real-time traffic monitoring controller 212 may conversely send or transmit information indicating the traffic level in (or aggregated from) the controller's associated on-die traffic network 208, real-time processing systems 204-206, etc., to one or more other dies (not shown in FIG. 2) in the form of transmitted D2D traffic status information 215. The transmitted D2D traffic status information 215 and the received D2D traffic status information 213 may be communicated through a device-to-device control plane (bus) that may be distinct from (i.e., a different set of wires) the D2D data communication link through which the TX data 222 and the RX data 224 are communicated.

The D2D link circuitry 210 may include D2D link physical-level interface (PHY) circuitry 216. The D2D PHY circuitry 216 may include transmit (TX) PHY circuitry 218 and receive (RX) PHY circuitry 220. The TX PHY circuitry 218 may be configured to provide the TX data 222 for transmission via the D2D data link (not separately shown in FIG. 2). Likewise, the RX PHY circuitry 218 may be configured to receive the RX data 224 from the D2D data link.

The D2D link circuitry 210 may further include a D2D link PHY controller 226. The D2D link PHY controller 226 may be configured for bidirectional data communication with the on-die traffic network 208 and the D2D PHY circuitry 216. That is, the D2D link PHY controller 226 may be configured to route data from the D2D PHY circuitry 216 to the on-die traffic network 208 and from the on-die traffic network 208 to the D2D PHY circuitry 216. The D2D link PHY controller 226 may also include a maintenance timer 228 and a link quality analyzer 230. The link quality analyzer 230 may be implemented in a finite state machine, for example.

The D2D link PHY controller 226 may be configured to perform one or more maintenance operations on the D2D link. For example, the D2D link PHY controller 226 may be configured to perform a calibration or data eye training operation. Although not separately shown for purposes of clarity, the D2D link PHY controller 226 may include a finite state machine configured to control data eye training. The D2D link PHY controller 226 may communicate with a similar D2D link PHY controller (not shown) in another die via the D2D link to coordinate the eye training.

The maintenance timer 228 may be configured to periodically trigger assertion of a D2D link downtime request signal 232. That is, the D2D link PHY controller 226 may assert the D2D link downtime request signal 232 based on the maintenance timer 228. For example, the maintenance timer 228 may be configured to trigger assertion of the D2D link downtime request signal 232 every T seconds (where T is an integer).

The link quality analyzer 230 may be configured to analyze the quality of the data eye associated with the data signals transmitted or received via the D2D link by the D2D PHY circuitry 216. The link quality analyzer 230 may provide a link quality indication 234 to the real-time traffic monitoring controller 212. The link quality indication 234 may also be referred to as D2D link status.

The D2D link PHY controller 226 may also assert the D2D link downtime request signal 232 based on link quality, i.e., a measurement of link quality provided by the link quality analyzer 230. Assertion of the D2D link downtime request signal 232 based on a measurement of link quality may be alternative to, or may be in addition to, the above-described assertion of the D2D link downtime request signal 232 based on the maintenance timer 228.

Although not shown, the D2D link PHY controller 226 may assert the D2D link downtime request signal 232 based on indicators of the performance status of the D2D link other than the eye quality. Such other indicators may be referred to as performance indicators or key performance indicators (KPIs).

The D2D link PHY controller 226 may assert the D2D link downtime request signal 232 based on still other events or conditions. For example, the D2D link PHY controller 226 may assert the D2D link downtime request signal 232 based on assertion of a frequency switching signal 235 by a device power management controller (not shown). Such a device power management controller may assert the frequency switching signal 235 to stall the D2D link traffic while the device power management controller switches the operational frequency of the D2D link.

In response to assertion of the D2D link downtime request signal 232, the real-time traffic monitoring controller 212 may determine whether to assert the D2D link downtime acknowledgement signal 236. The real-time traffic monitoring controller 212 may base this determination on a traffic level, which, as described above, may be an aggregate traffic level. For example, the real-time traffic monitoring controller 212 may assert the D2D link downtime acknowledgement signal 236 in response to assertion of the D2D link downtime request signal 232 if the aggregate traffic level is less than a link traffic threshold. It may be advantageous to defer performing a link maintenance operation until the traffic level decreases below the threshold. A very high traffic level may be challenging for the D2D link to handle, and stalling traffic while the traffic level is very high may adversely impact link performance.

In another example, the real-time traffic monitoring controller 212 may assert the D2D link downtime acknowledgement signal 236 in response to assertion of the D2D link downtime request signal 232 if the aggregate traffic level is less than the link traffic threshold and the link quality indication 234 indicates link communication quality impairment is less than a link quality threshold. Although in some examples impairment of the D2D link quality may indicate a need for D2D link maintenance, it may be advantageous to defer performing the link maintenance until the D2D link quality is less impaired. A very high link quality impairment may be challenging for the D2D link to handle, and stalling traffic while link quality impairment is very high may adversely impact link performance.

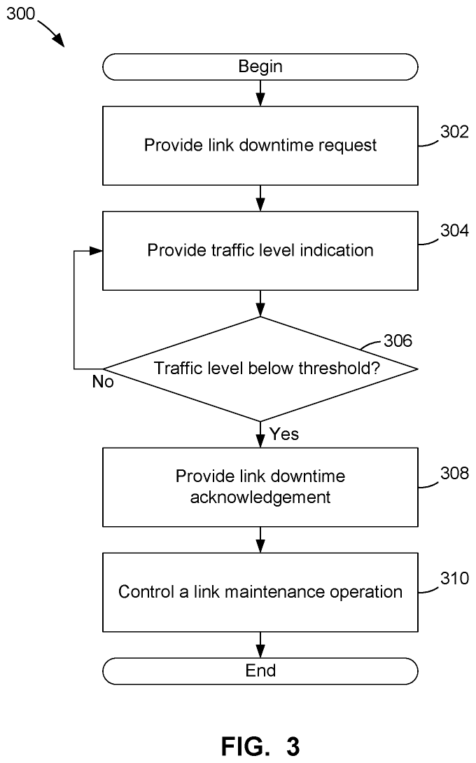

In FIG. 3, a method 300 for controlling D2D link traffic is illustrated in flow diagram form. Although the method 300 is described in the form of blocks indicating various operations in an order conducive to understanding an example, it should be understood that in other examples the operations may occur in other orders, and that in some examples operations may be omitted or additional operations not described herein may be included.

As indicated by block 302, the method 300 may include providing, by a component of a device such as a die, a link downtime request. As indicated by block 304, the method 302 may further include the component or device providing a traffic level indication. As described above, this traffic level indication may be an aggregate of one or more traffic levels in the device as well as one or more traffic levels in one or more other devices interconnected by the D2D link. As indicated by block 306, it may be determined whether the traffic level indication indicates that the (e.g., aggregate) traffic is less than a traffic threshold. As indicated by block 308, if the traffic level indication indicates the traffic is less than the traffic threshold, then the component or device may provide a link downtime acknowledgement. Then, in response to the link downtime acknowledgement, the device may control or perform a link maintenance operation, such as data eye training or frequency switching, as indicated by block 310.

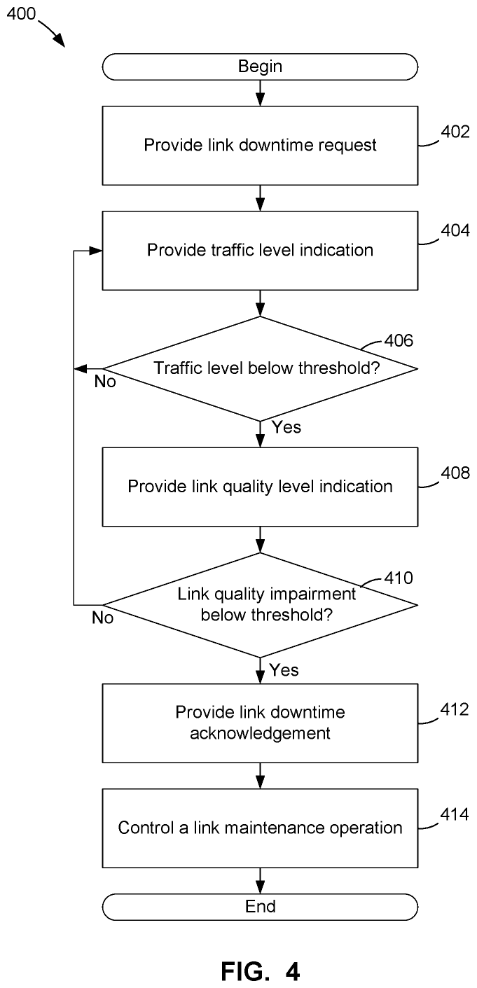

In FIG. 4, a method 400 for controlling D2D link traffic is illustrated in flow diagram form. Although the method 400 is described in the form of blocks indicating various operations in an order conducive to understanding an example, it should be understood that in other examples the operations may occur in other orders, and that in some examples operations may be omitted or additional operations not described herein may be included.

As indicated by block 402, the method 400 may include providing, by a component of a device such as a die, a link downtime request. As indicated by block 404, the method 402 may further include the component or device providing a traffic level indication. As described above, this traffic level indication may be an aggregate of traffic levels in the device as well as traffic levels in one or more other devices interconnected by a D2D link. As indicated by block 406, it may be determined whether the traffic level indication indicates the (e.g., aggregate) traffic is less than a traffic threshold.

As indicated by block 408, the method 400 may further include the component or device providing a link quality indication. As indicated by block 410, it may also be determined whether the link quality indication indicates link communication quality impairment is less than a link quality threshold. As indicated by block 412, if it is determined (block 406) that the traffic level is less than the traffic threshold, and if it is determined (block 410) that the link communication quality impairment is less than a link quality threshold, then the component or device may provide a link downtime acknowledgement. Then, in response to the link downtime acknowledgement, the device may control or perform a link maintenance operation, such as data eye training or frequency switching, as indicated by block 414.

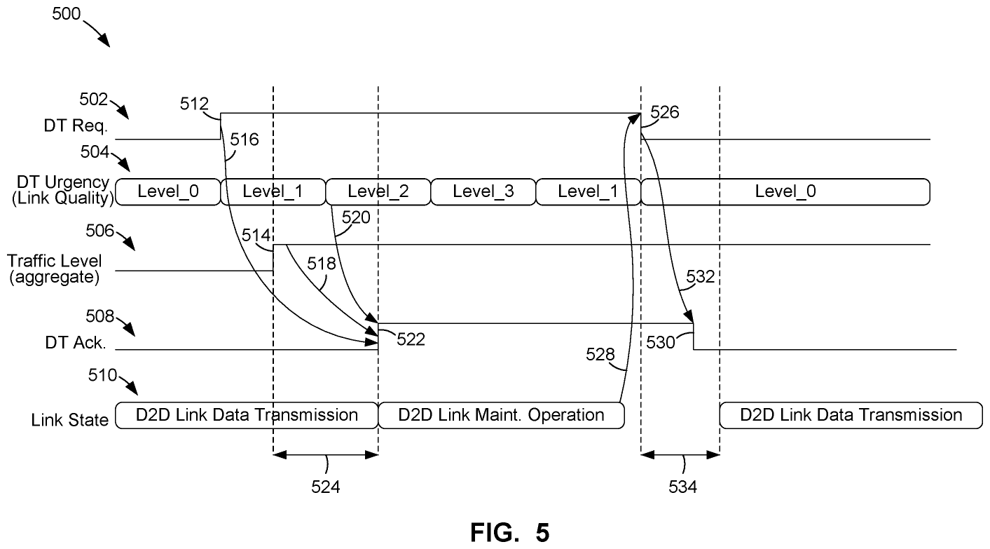

In FIG. 5, a timing diagram 500 further illustrates an example of aspects of the operation of a system for controlling a D2D data communication link. The timing diagram 500 may illustrate an example of aspects of the above-described system 200 (FIG. 2) or method 400 (FIG. 4). The timing diagram 500 illustrates: a link downtime (DT) request signal 502; a link quality (which may also be referred to as downtime urgency) indication 504; a traffic level signal 506; a link downtime acknowledgement signal 508; and a link state indication 510.

The illustrated example of operation begins with an assertion 512 (e.g., a transition from low to high) of the link downtime request signal 502. In this example, the link downtime acknowledgement signal 508 is not asserted unless three conditions occur. The first condition is the aforementioned assertion 512 of the link downtime request signal 502. The second condition is that the traffic level 506 is less than a traffic threshold. In the illustrated example, an assertion 514 (e.g., a transition from low to high) of the traffic level signal 506 indicates that the traffic level has decreased below the traffic threshold. The third condition is that any impairment of the D2D link communication quality is less than a link quality threshold.

In the illustrated example, the link quality indication 504 can have any of four states or levels: Level_0, indicating that the link quality is not impaired or is at the lowest level of impairment; Level_1, indicating that the link quality is more impaired than when Level_0 is indicated; Level_2, indicating that the link quality is more impaired than when Level_1 is indicated; and Level_3, indicating that the link quality is more impaired than when Level_2 is indicated. Although there are four link quality levels in the illustrated example, in other examples there may be any other number of link quality levels. The link quality level may also be referred to as downtime urgency. That is, the greater the link quality impairment, the more urgently the D2D link may need maintenance to alleviate the impairment. Nevertheless, when the link is at a very high level of impairment (in this example, Level_3), it may be disadvantageous to perform a maintenance operation because stalling the link while the link quality is highly impaired may exacerbate the effect on overall system performance of the impaired link. Rather, it may be advantageous to defer the maintenance operation until the link quality is somewhat less impaired. It may be advantageous to perform the maintenance operation when the link quality is within a range, such as, for example, at Level_2 (i.e., in the range between Level_1 and Level_3). In other words, it may be advantageous to perform link maintenance when the link quality impairment level is neither extremely low nor extremely high but rather at a level between these extremes.

In the illustrated example, when the assertion 514 of the traffic level signal 506 occurs, the link quality indication 504 indicates Level_1 impairment. However, in the illustrated example the link quality indication 504 changes from Level_1 impairment to Level_2 impairment. When the link quality indication 504 changes from Level_1 impairment to Level_2 impairment, the first, second and third above-described conditions have occurred, as indicated by the arrows 516, 518 and 520, respectively. In the illustrated example, an assertion 522 (e.g., transition from low to high) of the downtime acknowledgement signal 508 occurs in response to the combination of these three conditions. It should be understood that the combination of these three conditions is intended as an example, and in other examples of controlling a D2D data communication link such a downtime acknowledgement may be provided in response to other conditions or other combinations of conditions.

The assertion 522 of the downtime acknowledgement signal 508 may occur after a delay 524 rather than immediately upon the occurrence of the last of the above-described conditions. The delay 524 may be an amount or interval of time following the assertion 514 of the traffic level signal 506, i.e., an amount of time after the traffic level decreases below a threshold. The delay 524 may be selected to be sufficient to allow the various signals involved to settle to stable values, i.e., to reduce the likelihood of signal glitches affecting the operation of the relevant circuitry. Nevertheless, in other examples of controlling a D2D data communication link such a delay may be omitted.

When the assertion 522 of the downtime acknowledgement signal 508 occurs, the link state 510 may change from a state in which the D2D link is configured for data transmission (i.e., normal D2D link traffic) to a state in which the D2D link traffic is stalled. Once the D2D link traffic is stalled, a D2D link maintenance operation may be performed on the link. As described above, the D2D link maintenance operation may be of any type, such as, for example, data eye training, a link frequency change, etc. De-assertion 526 of the downtime request signal 502 may occur in response to completion of the D2D link maintenance operation, as indicated by the arrow 528. Then, de-assertion 530 of the downtime acknowledgement signal 508 may occur in response to the de-assertion 526 of the downtime request signal 502, as indicated by the arrow 532.

Following the de-assertion 526 of the downtime request signal 502, the link state 510 may change back from the stalled or link maintenance state to the active state in which the D2D link is configured for data transmission. This change of the link state 510 may occur after a delay 534 for the same glitch-resistance reason described above with regard to the delay 524.

It may be noted that in the illustrated example the link quality indication 504 changes from Level_2 to Level_3 when the link maintenance operation is begun. Nevertheless, the example illustrates that the subsequent improvement of the link quality indication 504 from Level_3 to Level_1 and then further to Level_0 after completion of the maintenance operation indicates that the link maintenance operation may have helped reduce link quality impairment.

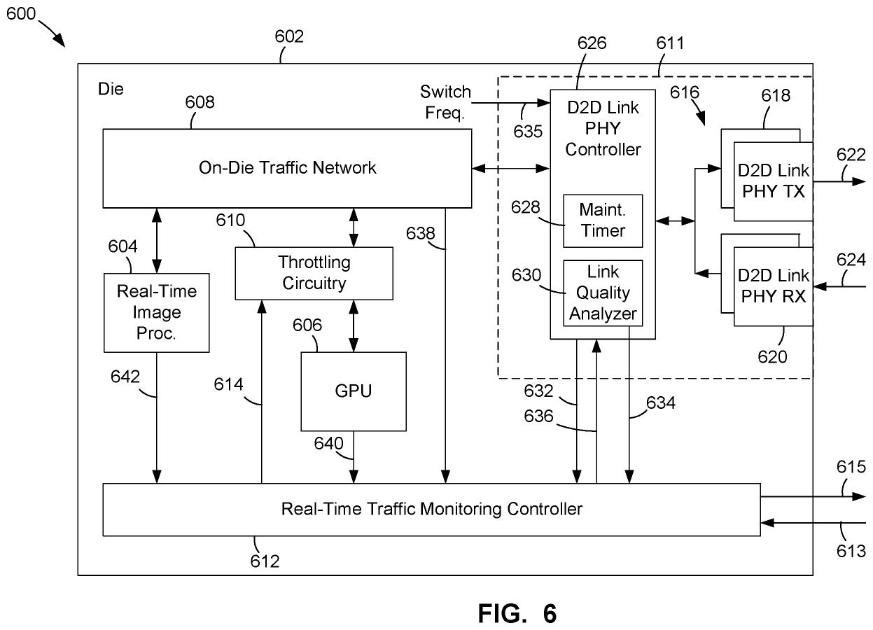

As shown in FIG. 6, a system 600 for controlling a D2D data communication link may comprise a device such as a die 602. The die 602 may include a real-time image processor 604 and a graphics processing unit (GPU) 606. As in the other examples described above, in the example shown in FIG. 6 the die 602 may include an on-die traffic network 608. The die 602 may further include throttling circuitry 610 configured to throttle traffic between the GPU 606 and the on-die traffic network 608. During downtime (i.e., when D2D link traffic is stalled), the throttling circuitry 610 may throttle this traffic to enable the GPU 606 to continue to operate but at a reduced or throttled rate of processing. When the downtime ends (e.g., D2D link maintenance has been completed) and the D2D link communication is restored, data that had been processed by the GPU 606 during the downtime may be transmitted over the D2D link.

The remainder of the system 600 may be similar to the above-described system 200 (FIG. 2). Accordingly, the die 602 may include D2D link circuitry 611 and a real-time traffic monitoring controller 612. A throttling signal 614 provided by the real-time traffic monitoring controller 612 to the throttling circuitry 610 may control the above-described throttling. The die 602 may also include D2D link PHY circuitry 616, comprising TX PHY circuitry 618 and RX PHY circuitry 620. The TX PHY circuitry 618 may be configured to provide TX data 622 for transmission via the D2D data link (not separately shown in FIG. 6), and the RX PHY circuitry 620 may be configured to receive RX data 624 from the D2D data link.

The D2D link circuitry 611 may include a D2D link PHY controller 626 configured in a manner similar to that described above with regard to the D2D link PHY controller 226 (FIG. 2). The D2D link PHY controller 626 may include a maintenance timer 628 and a link quality analyzer 630 that are similar to the above-described D2D link PHY controller maintenance timer 228 and a link quality analyzer 230 (FIG. 2). The real-time traffic monitoring controller 612 may receive traffic level monitoring (status) signals 638, 640 and 642 from the on-die traffic network 608, the GPU 606, and the real-time image processor 604, respectively.

The maintenance timer 628 and the link quality analyzer 630 may be configured to periodically trigger assertion of a D2D link downtime request signal 632. Assertion of a frequency switching signal 635 by a device power management controller (not shown) may also trigger assertion of the D2D link downtime request signal 632.

In response to assertion of the D2D link downtime request signal 632, the real-time traffic monitoring controller 612 may determine whether to assert the D2D link downtime acknowledgement signal 636. The real-time traffic monitoring controller 612 may perform this determination in a manner similar to that described above with regard to the real-time traffic monitoring controller 212 (FIG. 2). For example, the real-time traffic monitoring controller 612 may assert the D2D link downtime acknowledgement signal 636 in response to assertion of the D2D link downtime request signal 632 if an aggregate traffic level is less than a traffic threshold. Alternatively, the real-time traffic monitoring controller 612 may assert the D2D link downtime acknowledgement signal 636 in response to assertion of the D2D link downtime request signal 632 if the aggregate traffic level is less than the traffic threshold and a link quality indication 634 indicates link quality impairment is less than a link quality threshold.

The aggregate traffic level may be represented by the sum of fullness levels of various data buffers (not separately shown) in the on-die traffic network 608 and the fullness levels of similar data buffers in the on-die traffic networks of one or more other dies (not shown in FIG. 6). The real-time traffic monitoring controller 612 may base the aggregate traffic level on not only the aforementioned status signals based on data buffer fullness but also the status signals 640 and 642 provided by the GPU and real-time image processor 604, respectively. The real-time traffic monitoring controller 612 may receive indications of such traffic levels in other dies in the form of D2D traffic status information 613 and further base the aggregate traffic level indication on such traffic level indications. Conversely, the real-time traffic monitoring controller 612 may send or transmit information indicating the traffic level (e.g., a sum of data buffer fullness levels) in its associated on-die traffic network 608 to other devices, such as one or more other dies (not shown in FIG. 6) in the form of transmitted D2D traffic status information 615. The transmitted D2D traffic status information 615 and the received D2D traffic status information 613 may be communicated through a device-to-device control plane bus (not shown) that is distinct from (i.e., a different set of wires) the D2D data communication link through which the TX data 622 and the RX data 624 are communicated.

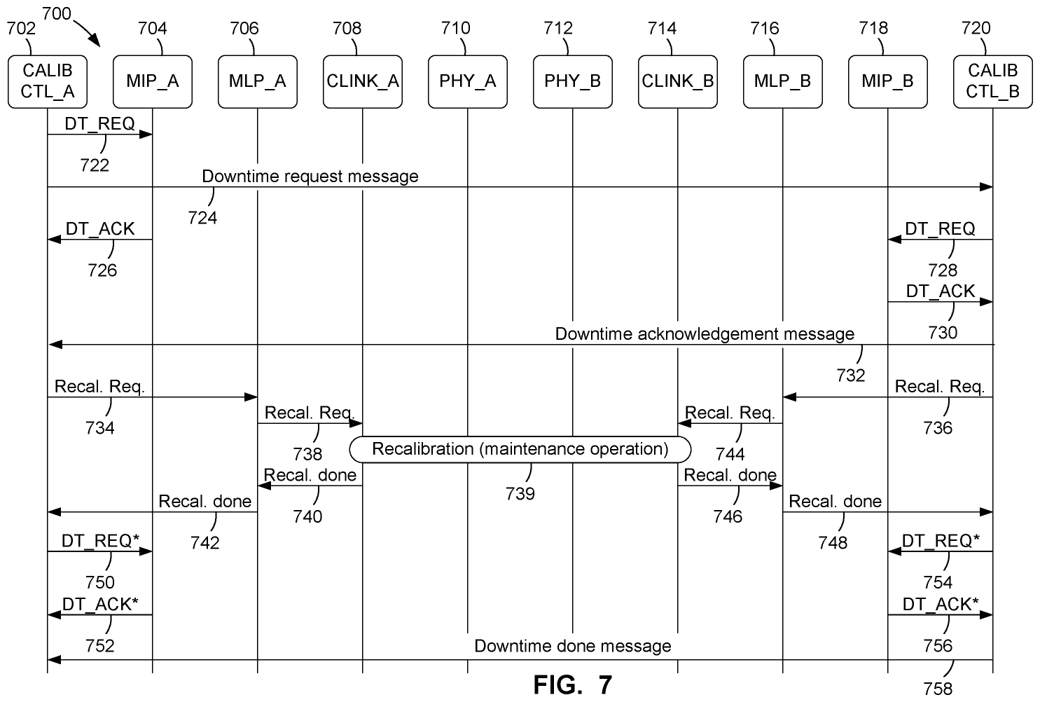

In FIG. 7, a signal flow diagram 700 further illustrates an example of aspects of the operation of a system for controlling a D2D data communication link. The signal flow diagram 700 may illustrate an example of aspects of operation of the above-described system 200 (FIG. 2) or 600 (FIG. 6). The example illustrated in FIG. 7 includes a calibration (also referred to as re-calibration) maintenance operation.

In the diagram 700, the following software-layer components may configure the hardware circuitry of a first one of the two chiplets or dies (not shown in FIG. 7) that are in communication with each other via the D2D link. A first calibration control component (CALIB CTL_A) 702 may configure the D2D link PHY controller 226 (FIG. 2) or 626 (FIG. 6) of the first die. A first maintenance processor (MIP_A) 704 may configure the real-time traffic monitoring controller 212 (FIG. 2) or 612 (FIG. 6) of the first die. A first multi-link PHY (MLP_A) 706 may configure the D2D link PHY controller 226 (FIG. 2) or 626 (FIG. 6) of the first die. A first chiplet link (CLINK_A) 708 may further configure the D2D link PHY controller 226 (FIG. 2) or 626 (FIG. 6) of the first die. A first PHY component (PHY_A) 710 may configure the D2D link PHY interface circuitry 216 (FIG. 2) or 616 (FIG. 6) of the first die.

A second PHY component (PHY_B) 712, a second chiplet link (CLINK_B) 714, a second multi-link PHY (MLP_B) 716, a second maintenance processor (MIP_B) 718, and a second calibration control component (CALIB CTL_B) 720 may configure corresponding hardware circuitry in the second die in the same above-described manner in which the first PHY component 710, first chiplet link 708, first multi-link PHY 706, first maintenance processor 704, and first calibration control component 702, respectively, configure hardware circuitry in the first die. That is, the hardware circuitry in the first and second dies that is relevant to the illustrated operational aspects may be configured in the same manner as each other. In an example of operation, the foregoing software-layer components (via the associated configured hardware circuitry) may communicate signals, messages, or other indications as follows.

The example of operation illustrated in FIG. 7 begins with the first calibration control component 702 providing or sending a downtime request (DT_REQ) 722 to the first maintenance processor 704. As described above, the downtime request 722 may be based on, for example, a periodic timer, a measurement of link quality, other conditions or events, or combinations thereof. In conjunction with the downtime request 722, the first calibration control component 702 may also send a D2D downtime request message 724 to the second calibration control component 720 in the second die. This D2D downtime request message 724 may be sent via the D2D communication link. In response to the downtime request signal 722 from the first calibration control component 702, the first maintenance processor 704 may return a downtime acknowledgement (DT_ACK) 726 to the first calibration control component 702. The first maintenance processor 704 may base whether to return the downtime acknowledgement 726 on a data traffic level. For example, the first maintenance processor 704 may return the downtime acknowledgement signal 726 if a data traffic level is less than a data traffic threshold. As described above, this data traffic level may be an aggregate of measurements of data traffic in the first and second dies. Although not shown in FIG. 7, such measurements of data traffic (also referred to as status information) may be communicated from the first die to the second die and from the second die to the first die.

Meanwhile, in the second die, based on the downtime request message 724 received from the first die, the second calibration component 720 may similarly provide or send a downtime request (DT_REQ) 728 to the second maintenance processor 718. In response to the downtime request 728 from the second calibration control component 702, the second maintenance processor 718 may return a downtime acknowledgement (DT_ACK) 730 to the second calibration control component 720. The second calibration control component 720 may also return a D2D downtime acknowledgement message 732 to the first calibration control component 702 in the first die. This D2D downtime acknowledgement message 732 may be sent via the D2D communication link. In this manner, the first and second dies may coordinate a maintenance operation. These acknowledgements may further be based on a data traffic level in the second die. For example, the second calibration control component 720 may base whether to return the downtime acknowledgement 730 and the D2D downtime acknowledgement message 732 on a data traffic level in the second die. For example, the second calibration control component 720 may return the downtime acknowledgement 730 and the D2D downtime acknowledgement message 732 if the data traffic level in the second die is less than a data traffic threshold. This (second) data traffic threshold on which the downtime acknowledgement 730 and the D2D downtime acknowledgement message 732 may be based may be different from the above-described (first) data traffic threshold on which the downtime acknowledgement 726 in the first die may be based.

In response to the D2D downtime acknowledgement 730 and the D2D downtime acknowledgement message 732, in the first die the first calibration control component 702 may send a recalibration request 734 to the first multi-link PHY 706, while in the second die the second calibration control component 720 may similarly send a second recalibration request 736 to the second multi-link PHY 716. In response to the recalibration request 734 in the first die, the first multi-link PHY 706 may send a further recalibration request 738 to the first chiplet link 708 to initiate a first portion or aspect of the recalibration (maintenance operation) 739. For purposes of clarity, the recalibration operation 739 is not shown in detail in FIG. 7, but it may be noted that the recalibration operation 739 may involve the first chiplet link 708, the first PHY component 710, the second PHY component 712, and the second chiplet link 714.

When the first portion of the recalibration is completed, the first chiplet link 708 may provide a recalibration done indication 740 to the first multi-link PHY 706. The first multi-link PHY 706 may, in turn, provide a further recalibration done indication 742 to the first calibration control component 702.

In response to the recalibration request 736 in the second die, the second multi-link PHY 716 may send a further recalibration request 744 to the second chiplet link 714 to initiate a second portion or aspect of the recalibration. When that second portion of the recalibration is completed, the second chiplet link 714 may send a recalibration done indication 746 to the second multi-link PHY 716. The second multi-link PHY 716 may, in turn, send a further recalibration done indication 748 to the second calibration control component 720.

In the first die, in response to the further recalibration done indication 742, the first calibration control component 702 may de-assert 750 the downtime request (DT_REQ*) provided to the first maintenance control processor 704. In response to this de-assertion of the downtime request, the first maintenance control processor 704 may de-assert 752 the downtime acknowledgement (DT_ACK*) provided to the first calibration control component 702. Similarly, in the second die, in response to the further recalibration done indication 748, the second calibration control component 720 may de-assert 754 the downtime request (DT_REQ*) provided to the second maintenance control processor 718. In response to this de-assertion of the downtime request, the second maintenance control processor 718 may de-assert 756 the downtime acknowledgement (DT_ACK*) provided to the second calibration control component 720. In the illustrated example, the second calibration control component 720 may send a D2D downtime done message 758 to the first calibration control component 702 to indicate that the second portion of the recalibration has been completed.

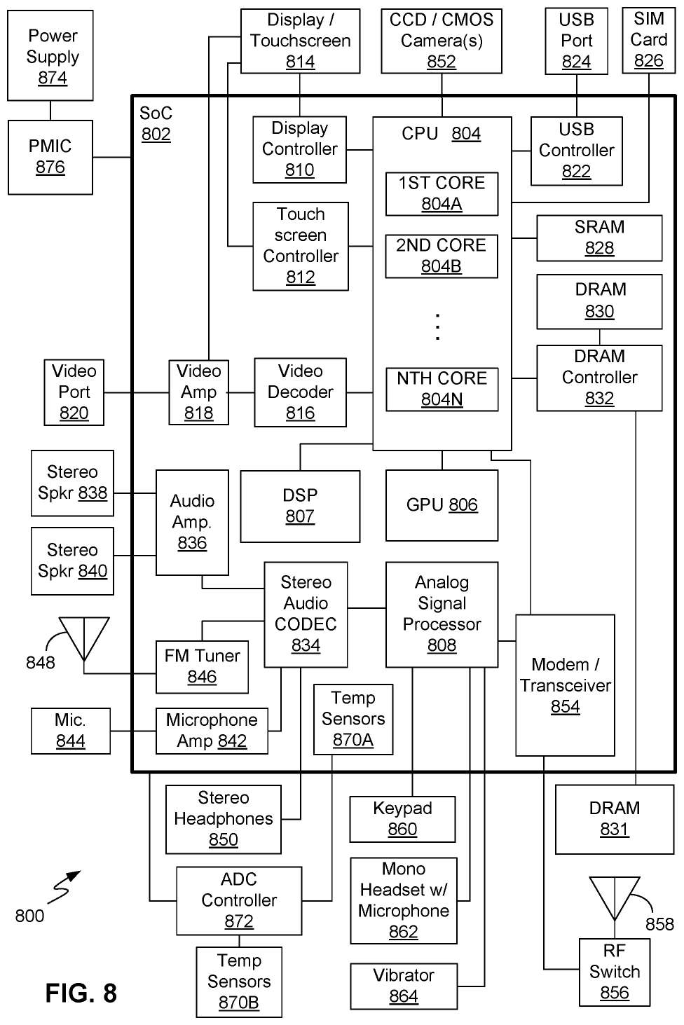

FIG. 8 illustrates an example of a portable computing device (PCD) 800, in which exemplary embodiments of systems, methods, and other examples of controlling a D2D data communication link may be provided. The PCD 800 may be, for example, a laptop or palmtop computer, cellular telephone or smartphone, personal digital assistant, navigation device, smartbook, portable game console, satellite telephone, automotive device, Internet-of-Things (IoT) device, etc. For purposes of clarity, some data buses, interconnects, signals, etc., are not shown in FIG. 8.

The PCD 800 may include an SoC 802 or multi-chip module, in which various processing components reside on different co-packaged dies or chiplets. For purposes of clarity in the block diagram of FIG. 8, such dies or chiplets are not indicated. The SoC 802 may include a CPU 804, a GPU 806, a digital signal processor (DSP) 807, an analog signal processor 808, a modem/modem subsystem 854, or other processors, some or all of which may reside on different dies or chiplets. The dies or chiplets may be interconnected by one or more buses or interconnects, such as, for example, PCIe buses, which may be configured to provide maintenance downtime in the manner described above. The CPU 804 may include one or more CPU cores, such as a first CPU core 804A, a second CPU core 804B, etc., through an Nth CPU core 804N.

A display controller 810 and a touch-screen controller 812 may be coupled to the CPU 804. A touchscreen display 814 external to the SoC 802 may be coupled to the display controller 810 and the touch-screen controller 812. The PCD 800 may further include a video decoder 816 coupled to the CPU 804. A video amplifier 818 may be coupled to the video decoder 816 and the touchscreen display 814. A video port 820 may be coupled to the video amplifier 818. A universal serial bus (USB) controller 822 may also be coupled to CPU 804, and a USB port 824 may be coupled to the USB controller 822. A subscriber identity module (SIM) card 826 may also be coupled to the CPU 804.

The CPU 804 may be coupled to one or more memories, with which the CPU 804 may initiate memory transactions. The one or more memories may include both volatile and non-volatile memories or NVMs. Examples of volatile memories include static random access memory (RAM) 828 and dynamic random access memory (DRAM) 830 and 831. Such memories may be internal to the SoC 802, as in the case of the DRAM 830, or external to the SoC, as in the case of the DRAM 831. A DRAM controller 832 coupled to the CPU 804 may control the writing of data to, and reading of data from, the DRAMs 830 and 831.

A stereo audio CODEC 834 may be coupled to the analog signal processor 808. Further, an audio amplifier 836 may be coupled to the stereo audio CODEC 834. First and second stereo speakers 838 and 840, respectively, may be coupled to the audio amplifier 836. In addition, a microphone amplifier 842 may be coupled to the stereo audio CODEC 834, and a microphone 844 may be coupled to the microphone amplifier 842. A frequency modulation (FM) radio tuner 846 may be coupled to the stereo audio CODEC 834. An FM antenna 848 may be coupled to the FM radio tuner 846. Further, stereo headphones 850 may be coupled to the stereo audio CODEC 834.

Other devices that may be coupled to the CPU 804 include one or more digital (e.g., CCD or CMOS) cameras 852. An example of real-time operation, to which the D2D link maintenance control solutions described herein may apply, is capturing video images using the cameras 852 and then processing the images as they are captured (i.e., in a real-time or streaming manner) using, for example, the GPU 806 and CPU 804. The methods and systems for controlling a D2D communication link to provide maintenance downtime may be used where, for example, the GPU 806 and CPU 804 are on different dies or chiplets that are coupled by such a D2D link.

The RF transceiver or modem subsystem 854 may be coupled to the analog signal processor 808 and the CPU 804. An RF switch 856 may be coupled to the modem subsystem 854 and an RF antenna 858. In addition, a keypad 860, a mono headset with a microphone 862, and a vibrator device 864 may be coupled to the analog signal processor 808.

The SoC 802 may have one or more internal or on-chip thermal sensors 870A and may be coupled to one or more external or off-chip thermal sensors 870B. An analog-to-digital converter controller 872 may convert voltage drops produced by the thermal sensors 870A and 870B to digital signals. A power supply 874 and a power management integrated circuit (PMIC) 876 may supply power to the SoC 802. The PMIC 876 may be an example of a component that provides the above-described frequency switching signal 235 (FIG. 2) or 635 (FIG. 6).

Implementation examples are described in the following numbered clauses.

1. A method for controlling a data communication link between a first device and a second device, comprising:
providing, by the first device, a first link downtime request;
providing, by the first device, a first data traffic level indication;
providing, by the first device, a first link downtime acknowledgement in response to the first link downtime request when the first data traffic level indication is less than a data traffic threshold; and
controlling, by the first device, a link maintenance operation in response to the first link downtime acknowledgement.

2. The method of clause 1, wherein the first data traffic level indication represents an aggregate data traffic level among the first device and at least one other device coupled to the data communication link.

3. The method of clause 1 or 2, wherein the first link downtime acknowledgement is provided when the first data traffic level indication is less than the data traffic threshold and a link quality indication indicates link communication quality impairment is less than a link quality threshold.

4. The method of any of clauses 1-3, wherein the first link downtime acknowledgement is provided after a time interval beginning when the data traffic level indication decreases below the data traffic threshold.

5. The method of any of clauses 1-4, wherein the first link downtime request is provided in response to at least one of: a periodic timer; and a link communication quality measurement.

6. The method of any of clauses 1-5, wherein:
providing the first link downtime request comprises providing, by a first physical-layer controller in the first device, the first link downtime request to a first traffic monitoring controller in the first device; and
providing the first link downtime acknowledgement comprises providing, by the first traffic monitoring controller, the first link downtime acknowledgement to the first physical-layer controller.

7. The method of clause 6, wherein the method further comprises:
providing, by the first physical-layer controller, a device-to-device downtime request message to the second device;
providing, by a second physical-layer controller in the second device, a second link downtime request to a second traffic monitoring controller in the second device in response to the device-to-device downtime request message;
providing, by the second traffic monitoring controller, a second data traffic level indication;
providing, by the second traffic monitoring controller, a second link downtime acknowledgement in response to the second link downtime request when the second data traffic level indication is less than the data traffic threshold; and
providing, by the second physical-layer controller, a device-to-device downtime acknowledgement message to the first device;
wherein the first physical-layer controller controls a first portion of the link maintenance operation in response to the device-to-device downtime acknowledgement message, and the second physical-layer controller controls a second portion of the link maintenance operation.

8. A system for controlling a device-to-device data communication link, comprising:
a first traffic network in a first device;
first link circuitry in the first device coupled to the first traffic network and coupled to the data communication link, the first link circuitry configured to provide a first link downtime request; and
a first traffic monitoring controller in the first device coupled to the first traffic network and the first link circuitry and configured to provide a first data traffic level indication, the first traffic monitoring controller further configured to provide a first link downtime acknowledgement in response to the first link downtime request when the first data traffic level indication is less than a data traffic threshold;
wherein the first link circuitry is further configured to control a link maintenance operation in response to the first link downtime acknowledgement.

9. The system of clause 8, wherein the first data traffic level indication represents an aggregate data traffic level among the first device and at least one other device coupled to the data communication link.

10. The system of clause 8 or 9, wherein the first traffic monitoring controller is configured to provide the first link downtime acknowledgement when the first data traffic level indication is less than the link traffic threshold and a link quality indication indicates link communication quality impairment is less than a link quality threshold.

11. The system of any of clauses 8-10, wherein the first traffic monitoring controller is configured to provide the first link downtime acknowledgement after a time interval beginning when the first data traffic level indication decreases below the data traffic threshold.

12. The system of any of clauses 8-11, wherein the first link circuitry is configured to provide the first link downtime request in response to at least one of: a periodic timer; and a link communication quality measurement.

13. The system of any of clauses 8-12, wherein:
the first link circuitry includes first physical-layer interface circuitry coupled to the data communication link and a first physical-layer controller configured to provide the first link downtime request; and
the first traffic monitoring controller is configured to provide the first link downtime acknowledgement to the first physical-layer controller.

14. The system of clause 13, further comprising
a second traffic network in a second device;
second link circuitry in the second device coupled to the second traffic network and coupled to the data communication link, the second link circuitry comprising second physical-layer interface circuitry coupled to the data communication link and a second physical-layer controller configured to provide a second link downtime request; and
a second traffic monitoring controller in the second device coupled to the second traffic network and the second link circuitry, wherein the first physical-layer controller is configured to provide a device-to-device link downtime request message, and the second physical-layer controller is configured to provide a device-to-device link downtime acknowledgement message;
wherein the first physical-layer controller is further configured to control a first portion of the link maintenance operation in response to the device-to-device link downtime acknowledgement message, and the second physical-layer controller is configured to control a second portion of the link maintenance operation.

15. A system for controlling a device-to-device data communication link, comprising:
a first device coupled to the data communication link, the first device configured to provide a device-to-device link downtime request message based on a first data traffic level, the first device further configured to control a first portion of a link maintenance operation; an
a second device coupled to the data communication link, the second device configured to control a second portion of a link maintenance operation based on the device-to-device link downtime request message and a second data traffic level.

16. The system of clause 15, wherein the first data traffic level indication represents an aggregate data traffic level among a plurality of devices coupled to the data communication link including the first device and the second device.

17. The system of clause 15 or 16, wherein the first device is configured to provide the device-to-device link downtime request message based on the first data traffic level and a measurement of link quality.

18. The system of any of clauses 15-17, wherein the first device is configured to begin the first portion of the link maintenance operation after a time interval beginning when the first data traffic level decreases below the data traffic threshold.

19. The system of any of clauses 15-18, wherein the first device is configured to provide the device-to-device link downtime request message in response to at least one of: a periodic timer; and a link communication quality measurement.

20. The system of any of clauses 15-19, wherein the link maintenance operation comprises data eye training.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A method for controlling a data communication link between a first device and a second device, comprising:
providing, by the first device, a first link downtime request;
providing, by the first device, a first data traffic level indication;
providing, by the first device, a first link downtime acknowledgement in response to the first link downtime request when the first data traffic level indication is less than a data traffic threshold; and
controlling, by the first device, a link maintenance operation in response to the first link downtime acknowledgement.

2. The method of claim 1, wherein the first data traffic level indication represents an aggregate data traffic level among the first device and at least one other device coupled to the data communication link.

3. The method of claim 1, wherein the first link downtime acknowledgement is provided when the first data traffic level indication is less than the data traffic threshold and a link quality indication indicates link communication quality impairment is less than a link quality threshold.

4. The method of claim 1, wherein the first link downtime acknowledgement is provided after a time interval beginning when the data traffic level indication decreases below the data traffic threshold.

5. The method of claim 1, wherein the first link downtime request is provided in response to at least one of: a periodic timer; and a link communication quality measurement.

6. The method of claim 1, wherein
providing the first link downtime request comprises providing, by a first physical-layer controller in the first device, the first link downtime request to a first traffic monitoring controller in the first device; and
providing the first link downtime acknowledgement comprises providing, by the first traffic monitoring controller, the first link downtime acknowledgement to the first physical-layer controller.

7. The method of claim 6, wherein the method further comprises:
providing, by the first physical-layer controller, a device-to-device downtime request message to the second device;
providing, by a second physical-layer controller in the second device, a second link downtime request to a second traffic monitoring controller in the second device in response to the device-to-device downtime request message;
providing, by the second traffic monitoring controller, a second data traffic level indication;
providing, by the second traffic monitoring controller, a second link downtime acknowledgement in response to the second link downtime request when the second data traffic level indication is less than the data traffic threshold; and
providing, by the second physical-layer controller, a device-to-device downtime acknowledgement message to the first device;
wherein the first physical-layer controller controls a first portion of the link maintenance operation in response to the device-to-device downtime acknowledgement message, and the second physical-layer controller controls a second portion of the link maintenance operation.

8. A system for controlling a device-to-device data communication link, comprising:
a first traffic network in a first device;
first link circuitry in the first device coupled to the first traffic network and coupled to the data communication link, the first link circuitry configured to provide a first link downtime request; and
a first traffic monitoring controller in the first device coupled to the first traffic network and the first link circuitry and configured to provide a first data traffic level indication, the first traffic monitoring controller further configured to provide a first link downtime acknowledgement in response to the first link downtime request when the first data traffic level indication is less than a data traffic threshold;
wherein the first link circuitry is further configured to control a link maintenance operation in response to the first link downtime acknowledgement.

9. The system of claim 8, wherein the first data traffic level indication represents an aggregate data traffic level among the first device and at least one other device coupled to the data communication link.

10. The system of claim 8, wherein the first traffic monitoring controller is configured to provide the first link downtime acknowledgement when the first data traffic level indication is less than the link traffic threshold and a link quality indication indicates link communication quality impairment is less than a link quality threshold.

11. The system of claim 8, wherein the first traffic monitoring controller is configured to provide the first link downtime acknowledgement after a time interval beginning when the first data traffic level indication decreases below the data traffic threshold.

12. The system of claim 8, wherein the first link circuitry is configured to provide the first link downtime request in response to at least one of: a periodic timer; and a link communication quality measurement.

13. The system of claim 8, wherein:
the first link circuitry includes first physical-layer interface circuitry coupled to the data communication link and a first physical-layer controller configured to provide the first link downtime request; and
the first traffic monitoring controller is configured to provide the first link downtime acknowledgement to the first physical-layer controller.

14. The system of claim 13, further comprising
a second traffic network in a second device;
second link circuitry in the second device coupled to the second traffic network and coupled to the data communication link, the second link circuitry comprising second physical-layer interface circuitry coupled to the data communication link and a second physical-layer controller configured to provide a second link downtime request; and
a second traffic monitoring controller in the second device coupled to the second traffic network and the second link circuitry, wherein the first physical-layer controller is configured to provide a device-to-device link downtime request message, and the second physical-layer controller is configured to provide a device-to-device link downtime acknowledgement message;
wherein the first physical-layer controller is further configured to control a first portion of the link maintenance operation in response to the device-to-device link downtime acknowledgement message, and the second physical-layer controller is configured to control a second portion of the link maintenance operation.

15. A system for controlling a device-to-device data communication link, comprising:
a first device coupled to the data communication link, the first device configured to provide a device-to-device link downtime request message based on a first data traffic level, the first device further configured to control a first portion of a link maintenance operation; and
a second device coupled to the data communication link, the second device configured to control a second portion of a link maintenance operation based on the device-to-device link downtime request message and a second data traffic level.

16. The system of claim 15, wherein the first data traffic level indication represents an aggregate data traffic level among a plurality of devices coupled to the data communication link including the first device and the second device.

17. The system of claim 15, wherein the first device is configured to provide the device-to-device link downtime request message based on the first data traffic level and a measurement of link quality.

18. The system of claim 15, wherein the first device is configured to begin the first portion of the link maintenance operation after a time interval beginning when the first data traffic level decreases below the data traffic threshold.

19. The system of claim 15, wherein the first device is configured to provide the device-to-device link downtime request message in response to at least one of: a periodic timer; and a link communication quality measurement.

20. The system of claim 15, wherein the link maintenance operation comprises data eye training.
